(19) United States
(12) Patent Application Publication
(10) Pub. No.: US 2021/0162412 A1
(43) Pub. Date: Jun. 3, 2021

(54) GATED PRECONCENTRATION DEVICES

(71) Applicant: University of Cincinnati, Cincinnati, OH (US)

(72) Inventors: Jason Charles Heikenfeld, Cincinnati, OH (US); Andrew Jajack, North Canton, OH (US)

(21) Appl. No.: 16/954,343

(22) PCT Filed: Dec. 21, 2018
(86) PCT No.: PCT/US2018/067158

§ 371 Date: Jun. 16, 2020

Related U.S. Application Data
(60) Provisional application No. 62/608,855, filed on Dec. 21, 2017.

(51) Int. Cl. B01L 3/00

(52) U.S. Cl. CPC B01L 3/502753; B01L 2300/044; B01L 2300/069; B01L 2400/049; B01L 2400/0683; B01L 2400/0688; B01L 2400/0694; B01L 2400/0472

(57) ABSTRACT

Described are sensing devices and methods that preconcentrate an analyte in a sample for sensing by one or more sensors. Embodiments utilize a semipermeable membrane that is impermeable to the analyte or analytes of interest but permeable to other components of the sample fluid. Embodiments utilize a concentrator pump that applies a force to the sample causing at least a portion of the permeable components of the sample fluid to cross the semipermeable membrane into the pump but that leave substantially all, i.e., greater than 99%, of the analyte or analytes of interest in the preconcentrated sample fluid. Embodiments may include gating components at the inlet to the device and, optionally, at the outlet of the device. Embodiments allow for the analyte or analytes of interest to be preconcentrated to a defined amount.

### BACKGROUND OF THE INVENTION

Biosensing technologies have enormous potential for applications ranging from athletics, to neonatology, to disease detection, to pharmacological monitoring, to personal digital health, to name a few applications. However, one repeated challenge with biosensing systems is the limit of detection of currently available sensors, especially when analytes of interest are highly dilute. Although concentrating analytes in a laboratory setting is widely utilized, translating these laboratory techniques and technologies out of the lab is not a trivial task. Many such attempts simply ‘duplicate’ a laboratory technique on a smaller scale, and do not fully capture the advances that miniaturization and automation can provide.

### SUMMARY OF THE INVENTION

Many of the drawbacks and limitations stated above can be resolved by creating novel and advanced interplays of chemicals, materials, sensors, electronics, microfluidics, algorithms, computing, software, systems, and other features or designs, in a manner that affordably, effectively, conveniently, intelligently, or reliably brings sensing technology into proximity with biofluid and analytes.

Embodiments of the disclosed invention are directed to preconcentration devices and methods that improve diagnostic and wellness sensing technologies. Embodiments of the disclosed invention provide preconcentration systems with advantages in shelf storage (e.g., it can be stored for a prolonged duration), with advantages of regulating the amount of preconcentration, with advantages of quickly and reliably providing a volume of preconcentrated sample, and with ease of integration with sensing technologies such as lateral flow assays and other point-of-care diagnostic tests.

Aspects of the invention are directed to sensing devices and methods that preconcentrate an analyte in a sample fluid for sensing by one or more sensors or for storage. Embodiments utilize a semipermeable membrane that is impermeable to the analyte or analytes of interest but permeable to other components of the sample fluid. Embodiments utilize a concentrator pump that applies a force to the sample causing at least a portion of the permeable components of the sample fluid to cross the semipermeable membrane into the pump but that leave substantially all, i.e., greater than 99%, of the analyte or analytes of interest in the preconcentrated sample fluid. Embodiments may include gating components at the inlet to the device and, optionally, at the outlet of the device. Embodiments allow for the analyte or analytes of interest to be preconcentrated to a defined amount.

### BRIEF DESCRIPTION OF THE DRAWINGS

The objects and advantages of the disclosed invention will be further appreciated in light of the following detailed descriptions and drawings in which:

FIG. 1A is a cross-sectional view of a preconcentration device according to an embodiment of the disclosed invention.

FIG. 1B is a cross-sectional view of the device of FIG. 1A while a fluid sample is being preconcentrated.

FIG. 1C is a cross-sectional view of the device of FIG. 1A after the fluid sample has been preconcentrated.

FIG. 2A is a cross-sectional view of a preconcentration device according to another embodiment of the disclosed invention.

FIG. 2B is a cross-sectional view of the device of FIG. 2A while a fluid sample is being preconcentrated.

FIG. 2C are cross-sectional views of the device of FIG. 2A after the fluid sample has been preconcentrated.

FIG. 3A is a cross-sectional view of a preconcentration device according to an embodiment of the disclosed invention.

FIG. 3B is a cross-sectional view of the device of FIG. 3A while a fluid sample is being preconcentrated.

FIG. 3C is a cross-sectional view of the device of FIG. 3A after the fluid sample has been preconcentrated.

FIG. 4A is a cross-sectional view of a preconcentration device according to another embodiment of the disclosed invention.

FIG. 4B is a cross-sectional view of the device of FIG. 4A after a sample is loaded onto the inlet reservoir.

FIG. 4C is a cross-sectional view of the device of FIG. 4A after seal to inlet reservoir is ruptured allowing the sample to enter the fluidic channel

FIG. 4D is a cross-sectional view of the device of FIG. 4A showing the sample during preconcentration.

FIG. 4E is a cross-sectional view of the device of FIG. 4A showing the sample after preconcentration.

FIG. 4F is a cross-sectional view of the device of FIG. 4A showing the insertion of a sensor into the device after the sample has been preconcentrated.

FIG. 5A is a cross-sectional view of a preconcentration device according to an embodiment of the disclosed invention.

FIG. 5B is a cross-sectional view of the device of FIG. 5A while a fluid sample is being preconcentrated.

FIG. 5C is a cross-sectional view of the device of FIG. 5A after the fluid sample has been preconcentrated.

FIG. 6 is a cross-sectional view of a preconcentration device according to an embodiment of the disclosed invention.

### DEFINITIONS

As used herein, “fluid sample” or “sample fluid” means a fluid source of analytes. Fluid samples can include blood, saliva, tears, sweat, interstitial fluid, plant biofluids, river water, fluids used in chemical processing plants, or other possible sample fluids.

### DETAILED DESCRIPTION OF THE INVENTION

Embodiments of the disclosed invention are directed to preconcentration systems that quickly and reliably provide a volume of preconcentrated sample to be sensed (i.e., analyzed) and easily integrate with sensing technologies, such as lateral flow assays. Advantageously, embodiments of the present invention may be stored in a dry state, which extends shelf life, and regulate the amount of preconcentration of the sample as described below.

Certain embodiments of the disclosed invention show sensors as simple individual elements. It is understood that many sensors require two or more electrodes, reference electrodes, or additional supporting technology or features which are not captured in the description herein. Sensors measure a characteristic of an analyte. Sensors are preferably electrical in nature, but may also include optical, chemical, mechanical, or other known biosensing mechanisms. Sensors can be in duplicate, triplicate, or more, to provide improved data and readings. Sensors may provide continuous or discrete data and/or readings. Sensors may also include lateral flow assays such as an influenza test or pregnancy test, or DNA amplification techniques such as molecular diagnostics. Certain embodiments of the disclosed invention show sub-components of what would be sensing devices with more sub-components needed for use of the device in various applications, which are known (e.g., a battery, antenna, adhesive), and for purposes of brevity and focus on inventive aspects, such components may not be explicitly shown in the diagrams or described in the embodiments of the disclosed invention.

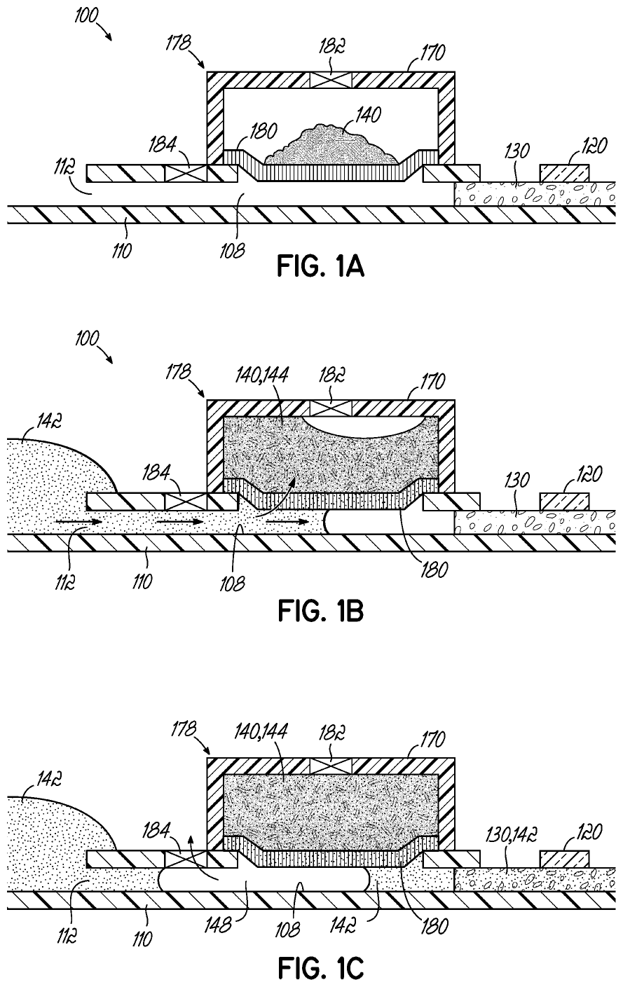

With reference to FIG. 1A, in an embodiment of the disclosed invention, a device 100 is configured to preconcentrate a fluid sample before it is sensed by a sensor. The device 100 includes a fluid channel 108, which may be an open channel with boundaries defined by fluid impermeable substrates 110 or may be a wicking material. Suitable materials for the substrates 110 include, for example, acrylic, PET, glass, or other suitable liquid impermeable materials.

The device 100 further includes a wicking material 130 in fluid communication with the channel 108. The wicking material 130 transports fluid from the channel into contact with a sensor 120 and may be made of, for example, a gel, a textile, a paper, a wicking microchannel or plurality of microchannels, or a material such as those used in lateral flow assays.

The sensor 120 may be any suitable sensor such an electrochemical aptamer, an electrochemical enzymatic sensor, one incorporating a chromophore like those used in lateral flow assays, etc. Between the sample inlet 112 of the channel 108 and the wicking material 130 is a semi-permeable membrane 180, which is provided along a portion of the channel 108 between the channel 108 and the draw reservoir 178, as described below. The semi-permeable membrane 180 has pores having a diameter that prevents passage of the analyte in the sample across the semi-permeable membrane 180. In an embodiment, the pores of the semi-permeable membrane have a diameter that is less than the width of the analyte to be concentrated in the fluid sample. Suitable materials for the membrane 180 include, without limitation, a dialysis membrane or forward osmosis membrane (such as the Rainstick membrane manufactured by Fluid Technology Solutions, Inc.), an ultrafiltration membrane, or nanofiltration membrane, depending on the analyte being concentrated.

The draw reservoir 178 is defined by housing 170 and the membrane 180 and functions as a concentrator pump that includes a draw material 140. The housing 170 may be made of, for example, plastic, glass, or metal. The draw material 140 may be in a dry or semi-dry form (e.g. a hydrogel with 10% water to prevent cracking) and, in combination with the membrane 180, serves to concentrate a fluid sample before it reaches the sensor 120. Suitable draw materials 140 include, without limitation, sugars (e.g., sucrose), salts (e.g., NaCl), polyelectrolytes (e.g., polyethylenimine), or other suitable materials. In an embodiment, the draw material 140 is a wicking material with a wicking strength greater than that of the wicking material 130. Each of the substrates 110 and the housing 170 may contain optional hydrophobic air vents 182, 184, which may be a porous membrane, such as Teflon®, or another suitable material.

With reference to FIG. 1B, a fluid sample 142 is introduced at the sample inlet 112 and wicks into the channel 108 by capillary action towards the wicking material 130. As the sample 142 moves across the membrane 180, the sample 142 loses water due to the draw reservoir 178 functioning as a concentrator pump which, in this embodiment, uses a concentration gradient to exert a force to draw water and/or solutes though the membrane 180. As the water enters the draw reservoir 178, the water and draw material 142 form a solution 144. Without evaporation of the water, this is a one-time use device 100. Because of the draw flow rate across the membrane 180, the sample fluid is initially unable to reach the wicking material 130. As the water enters the draw reservoir, air may be forced out of the optional air vent 182.

As shown in FIG. 1C, the device 100 reaches a state where the draw rate through the membrane 180 either ceases or slows adequately to the point where the now preconcentrated sample fluid 142 moves forward through the channel 108 and reaches the wicking material 130. If wicking material 130 has adequate wicking strength, it can quickly pull a sufficient volume of preconcentrated sample fluid onto the sensor 120. Optional hydrophobic vent 184 may allow air 148 to be pulled into the channel 108 such that more rapid transport of sample onto wicking material 130 is permitted (e.g., not subject to flow resistance at the inlet). The air-vent area 184 may need to be small, such that capillary action can occur past or around the air vent 184. Although there could be back diffusion of solutes towards the inlet 112, if the device 100 operation is fast (e.g. minutes) the effect of back diffusion will be minimal for at least large analytes such as proteins. Vent 184 could also be a dissolvable polymer film, such as PVA, or any other feature or component that initially promotes fluid transport past such a component and then allows air to enter the device such that fluid moves onto the sensor 120 with less or nearly zero fluid resistance to flow. In this manner, such vents 184 could be provided at one or more locations in the device 100, to provide such functionality, including before and after or as part of the membrane 180. Alternately, vents could be alongside channels (not shown) that do not wet with fluid, and the side channel and the vent together form a vent. As a result of the general design of the device 100, the device prevents the fluid sample from reaching the one or more sensors 120 until a defined amount of fluid is removed from the fluid sample, saturating the wicking material or nearing a concentration gradient of zero. Since vents 182, 184 influence the forward flow of the fluid sample, they are, therefore, considered gating components. Also, as a result of the general design of the device 100, an assay receives fluid with a flow rate that is less than at least one of 1×, 0.5×, 0.25×, or 0.1× of the input flow rate, or of the flow rate that would result from a device having the same structure but lacking a concentrator pump.

With further reference to FIGS. 1A-1C, in an aspect of the disclosed invention, the amount of preconcentration of the sample may be controlled, e.g., to a defined amount of preconcentration. In embodiments of the invention, the amount of draw material may be configured to provide a 100× preconcentration of the target analyte in the sample. For example, if the device 100 has a draw material that includes 5M NaCl and the sample solution has 50 mM NaCl, then it can provide 100× preconcentration of the sample, including 100× preconcentration of an analyte in the sample, such as cortisol, vasopressin, or a viral protein or antibody. In another embodiment, the device 100 may use the volume of the housing 170 of the draw reservoir 178 to volume constrain the amount of preconcentration of the target analyte in the sample. In an embodiment where the draw material 140 is a wicking material, the wicking material itself may become volume constrained (e.g., once it fully wicks with fluid, it ceases to draw more fluid). The device 100 may be designed to favor even faster preconcentration and faster transport to the sensor 120 (e.g., less than 5 minutes) by not relying fully on osmotic balance or other ways to cease draw of fluid before sample fluid is wicked onto the sensing portion of the device 100. Depending on final osmotic balance and total concentrations, operation time can range from less than 1 minute to 10's of minutes. Accordingly, in embodiments of the invention, the operation time of the device is less than 1 minute or in a range from 30 seconds to 1 minute, or in a range from minute to 30 minutes, or in a range from 1 minute to 20 minutes, or in a range from 1 minute to 15 minutes.

Although a sensor 120 is shown and described, it may also be optional, and wicking material 130 may be a material to receive the sample (e.g., a receiving portion of the device) which may then be used to transport the preconcentrated sample to a separate analysis or storage container. The preconcentration sample, for example, may be transported to a molecular diagnostic test (i.e. DNA amplification) such as polymerase-chain reaction (PCR) tests or Loop-mediated isothermal amplification (LAMP) tests, as well as other traditional assays (e.g. enzyme-linked immunosorbent assay).

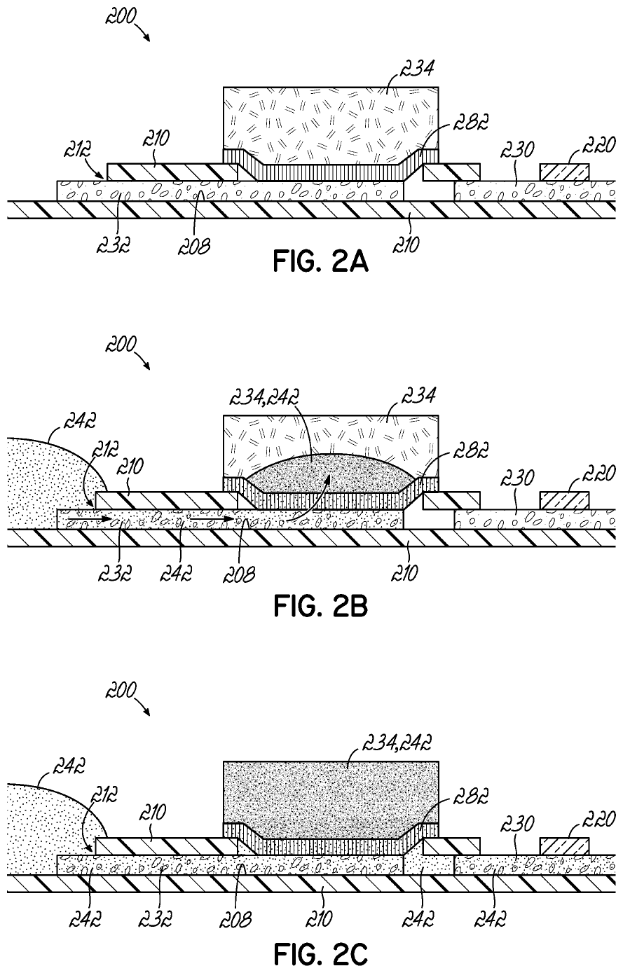

With reference to FIGS. 2A-2C, a device 200 is also capable of preconcentrating a sample before the sample is sensed. The device 200 includes a fluid channel 208 between substrates 210 that contains a pair of wicking materials 232, 230, which are in fluid communication but not direct contact. The upstream wicking material 232 is upstream of the downstream wicking material 230 and may be made of, for example cellulose, or a material with low non-specific binding of analyte, including open microfluidic materials or a matrix of packed hydrophilic glass beads where fluid wicks between the beads.

A semi-permeable membrane 282 is provided along a portion of the fluid channel, at least a part of which contacts the upstream wicking material 232. The membrane 282 separates the fluid channel from a concentrator pump which in this embodiment is a wicking draw material 234. The wicking draw material may be made of cellulose (e.g., paper) or other materials capable of wicking liquid from the sample across membrane 282.

The membrane 282 may be, for example, a dialysis membrane or track-etch membrane that preconcentrates larger analytes (e.g., molecules, large molecules, proteins, etc.) but which allows small solutes (e.g., those that affect pH and salinity) to pass through membrane 282. Exemplary materials for membrane 282 are the same as those described above with respect to membrane 182 in device 100.

With reference to FIG. 2B, the fluid sample 242 is introduced to the upstream wicking material 232 of the device 200 and rapidly wicks to fill the wicking volume of the upstream wicking material 232. This allows a more uniform flow of sample below the membrane 282 and can therefore help prevent over-preconcentration of the leading edge of the sample 242. Over-preconcentration is a particular concern for the device 200 because the wicking draw material 234 is based on wicking and not based on osmotic pressure. As shown, wicking draw material 234 draws in sample 242 at a rate such that sample 242 is not yet able to reach the downstream wicking material 230 by wicking pressure. Again, the same system may work without wicking pressure to reach the downstream wicking material 230 and instead of capillary or wicking action to pull in the sample 242, may use for example positive pressure at the inlet 212 of the device 200 (e.g., a syringe pump, not shown). If, for example, membrane 282 has a molecular weight cut-off of 2000 Da, it transports both water and small solutes from the sample into the wicking draw material 234 thereby preventing a large change in pH or salinity for the sample 242 being preconcentrated beneath the membrane 282.

With reference to FIG. 2C, the upstream wicking material 232 reaches sufficient, close to, or its full, wicking capacity. For the disclosed invention, another way to interpret this is that wicking draw material 234 is adequately filled with sample 242 such that flow a rate of water into wicking draw material 234 slows enough such that sample 242 is able to proceed onto the sensing portion 220, which may include an analyte-specific sensor. As a result of this configuration, downstream wicking material 230 is optional (e.g., the sensor may be in a microfluidic channel extending from the membrane 282 past the sensing portion 220), but the downstream wicking material 230 is advantageous in some embodiments as it can speed the transport of preconcentrated sample to the sensing portion 220 by virtue of a strong wicking force.

Like the use of osmotic balance, the amount of preconcentration can be defined using the wicking capacity of the wicking draw material 234. For example, the upstream wicking material 232 may have a volume capacity of 100 nL beneath the membrane 282, and wicking draw material 234 may have a volume of capacity of 2 μL to provide a precise 20× amount of preconcentration. Therefore, the device is configured to prevent the fluid sample from reaching the one or more sensors until a predetermined amount of fluid is removed from the fluid sample or until a defined volume is reached, as determined by the volume of the wicking draw material.

The embodiments of the devices described herein have one or more of the following distinct advantages over other types of sample preconcentration devices. First, the device may permit easy dry shelf storage. Additionally, the device may self-regulate the amount of preconcentration of the analyte in the sample and holds onto the sample fluid until it reaches adequate level of preconcentration at which point it quickly releases an adequate volume of sample fluid onto the sensing portion of the device. This is important for time-sensitive type sensors such as those used in lateral flow assays and glucose test strips. Further, the device is low cost and simple to manufacture and operate. In various embodiments, the device can include techniques/materials to allow more uniform preconcentration with time (e.g., preventing over preconcentration of the leading edge of the sample). Additionally, the device may be configured, such as through the combination of membranes and draw materials to remove small molecules and solutes from the sample being concentrated to avoid large changes in salinity or pH.

In an embodiment, the device may include a buffering chemical, material, or device portion before or after the preconcentration portion (not shown), which is advantageous if the sensing portion requires a narrow pH, salinity, or other issue related to solute content in the sample fluid.

In an embodiment, the device includes one or more dry buffering or salt mitigation materials. For example, dry citrate power could be used to buffer pH in the device and be included in any channel location or wicking material, and stored dry. For example, where high salinity is an issue, ion-exchange resin or other material could be added that have strong ion-exchange properties and that could absorb ions, such as Na+ and Cl—, thereby reducing salinity.

In an embodiment, the device includes at least one chemical component necessary for downstream sensing. For example, lyophilized conjugate antibodies could be included in any channel location or wicking material. An advantage of this approach is that analytes of interest would have adequate time to conjugate with antibodies during concentration ensuring near perfect conjugation prior to passing downstream capture antibodies.

In an embodiment, the device includes at least one integrated method of measuring the amount of preconcentration that has occurred (e.g., an Ag/AgCl sensor at the inlet and outlet which measures the amount of preconcentration by the amount increase of Cl ions, for example, with the device 100 of FIG. 1A.

In an aspect of the disclosed invention, the rate of sample fluid introduction into the device channel 108 and the draw rate of water through the membrane 180 could also be regulated by flow resistance or other means such that the preconcentration does not occur too quickly for all or a portion of the sample fluid, which could cause precipitation of the analytes to be sensed. This is unlikely to be a major issue for osmotic-driven preconcentration but could be a significant issue for wicking-based preconcentration, which could over-concentrate the initial sample introduced into the sample. This issue with potential over-preconcentration can also be mitigated using the techniques described for the device 200.

In an embodiment, the devices are able to provide preconcentration greater than at least one of 2×, 5×, 10×, 50×, or 100×. In an embodiment, the devices are able to provide salt concentrations in the preconcentrated sample changed by less than at least one of 10×, 5×, 2×, 0.5×, 0.25×, 0.1×, or 0.05×. In an embodiment, the devices are able to provide pH in the preconcentrated sample changed by less than at least one of 1000×, 100×, 10×, 2×, or 0.5× (e.g. in terms of linear concentration, not the log scale of pH).

In an embodiment, the devices are able to provide a sensor, an assay, or a sample reservoir positioned past said membrane and receiving preconcentrated solution from portion of said device that has said membrane. For example, sensors or assays as taught herein could be replaced with fluid holders, wicking materials, vials, or other suitable features to receive a sample from said device which could then be preserved, sensed by other means, or utilized in other ways that benefit from preconcentration.

In an embodiment, the devices as taught herein can benefit from use of positive pressure driven flow (e.g. fluid being pushed into such a device). In this embodiment, a syringe pump, blister pack, or other material could be used to push fluid into the device. The device could operate similar to the device illustrated in FIG. 2A, even with positive pressure, if the input flow resistance and wicking strength of the wicking draw material 234 is strong enough to allow auto-staged fluid movement as taught for FIG. 2A. Alternately, wicking draw material 234 could be replaced with an open or hollow reservoir that fills to a proper volume (e.g. not a wicking material), and after it fills, pressure transfers fluid onto the rest of the device. For example, at least one device area or feature or region between the membrane 282 and sensor 220 could be hydrophobic, requiring a positive pressure to push fluid through such hydrophobic region. These hydrophobic regions can be considered gating components that prevents the fluid sample from advancing past the region until a user's action e.g., applying a positive pressure to the fluid.

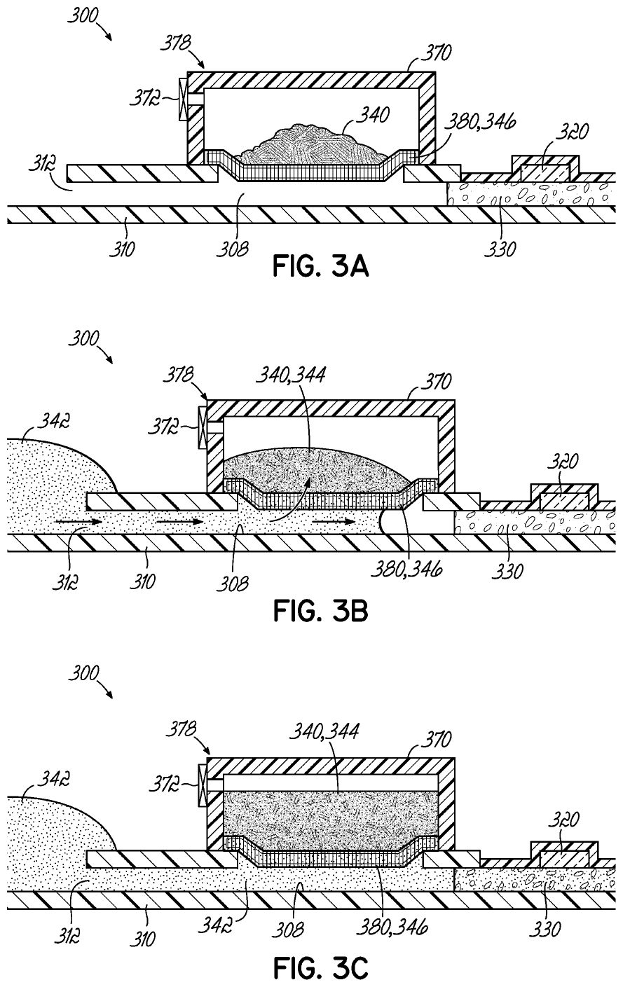

With reference to FIG. 3A, in an embodiment of the disclosed invention, a device 300 is configured to preconcentrate a fluid sample before it is sensed by a sensor 320. The device 300 includes a fluid channel 308, which may be a microfluidic channel defined by fluid impermeable substrates or material 310 or may be a wicking material. Suitable materials for the substrates 310 include, for example, acrylic, PET, glass, or other suitable materials. The device 300 further includes a wicking material 330 in fluid communication with the channel 308. The wicking material 330 transports fluid from the channel into contact with a sensor 320 and may be made of, for example, a gel, a textile, a wicking microchannel or plurality of porous channels, or a material such as those used in lateral flow assays.

The sensor 320 may be any suitable sensor for sensing or analyzing an analyte in a sample, such an electrochemical aptamer, an electrochemical enzymatic sensor, or a sensor incorporating a chromophore like those used in lateral flow assays, etc.

Between the sample inlet 312 of the channel 108 and the wicking material 330 is a semi-permeable membrane 380, which is provided along a portion of the length of the channel 308 between the channel 308 and a draw reservoir 378. The semi-permeable membrane 380 has pores having a diameter that prevents passage of the analyte in the sample across the semi-permeable membrane 380. In an embodiment, the pores of the semi-permeable membrane have a diameter that is less than the width of the analyte to be concentrated in the fluid sample. Suitable materials for the membrane 380 include, without limitation, a dialysis membrane or forward osmosis membrane (such as the Rainstick membrane manufactured by Fluid Technology Solutions, Inc.), an ultrafiltration membrane, or nanofiltration membrane, depending on the analyte being concentrated. This membrane is coated internally with a gas impermeable substance 346, which in an example is a semi-viscous liquid. This substance 346 is held in the membrane pores by Laplace pressure. This pressure is extremely high because of its high surface tension, as well as the extremely small effective pore size of the membrane 380. In another embodiment of the disclosed invention, the gas impermeable substance 346 is a solid dissolvable coating such as sucrose.

The device 300 further includes a gas impermeable housing 370 external to the semi-permeable membrane 380. The gas impermeable housing 370 and the membrane 380 define the concentrator pump which in this embodiment consists of a draw reservoir 378 that is at least initially impermeable to gas. The draw reservoir 378 sustains vacuum because the pressure or force holding the substance 346 in the membrane pores is much higher (e.g. ˜480 atm for propylene glycol and dialysis membrane) than that of vacuum (1 atm). The housing 370 may be made of, for example, a gas impermeable plastic, glass, or metal. In this embodiment, the concentrator pump uses a pressure gradient between the evacuated draw reservoir and the atmosphere (15 psi). The vacuumed draw reservoir 378, in combination with the membrane 380, serves to concentrate a fluid sample before it reaches the sensor 320.

A gating component 372 is optional and is present on the side of the housing 370. In an embodiment, the vacuum draw reservoir 378 has a greater wicking strength than that of the channel formed between substrate materials 310 or than that of the wicking material 330. An optional draw rate increasing material 340 may be present in the vacuumed draw reservoir 378 that increases the rate of draw. Draw rate increasing material 340 could also be a polyelectrolyte or wicking material that increases draw rate by adding osmotic pressure and/or wicking pressure.

With reference to FIG. 3B, a fluid sample 342 is introduced at the sample inlet 112 and wicks into the channel. 1081by capillary action towards the wicking material 330. As the sample 342 moves across the membrane 380, the sample fluid 342 displaces and/or dissolves the substance 346, and begins moving into the reservoir 378 because of the vacuum's draw of 1 atm. Because the sample fluid 342 only temporarily displaces the substance 346 from the membrane pores, vacuum is almost completely maintained. As the sample fluid 342 enters the draw reservoir 378, the fluid. Without evaporation of the water, or other ways to maintain vacuum, this is a one-time use device 300. Because of the high draw flow rate across the membrane 380, the sample fluid is initially unable to reach the wicking material 330.

As shown in FIG. 3C, the fluid 342 in device 300 reaches a state where the volume of fluid drawn through the membrane 380 reaches the level of the gating component 372, made up of a dissolvable material such as sucrose or gelatin film that rapidly dissolves after coming into contact with the sample fluid. When the sample fluid dissolves the gating component 372, the vacuum reservoir repressurizes, and the flow through membrane 380 slows or ceases. The now preconcentrated sample fluid 342 moves forward through the channel and reaches the wicking material 330. As a result of the general design of the device 300, the device prevents the fluid sample from reaching the one or more sensors until a defined amount of fluid is removed from the fluid sample as determined by the volume of the concentrator pump and/or location of the gating component. Also, as a result of the general design of the device 300, the assay receives fluid with a time lag that is compared to a device with the same assay and having no preconcentration that is less than at least one of 100×, 50×, 20×, 10×, 5×, or 2×, different than time lag would be for said device without preconcentration. Said differently, the device could complete preconcentration with a lag time of less than 60, 20, 10, 5, 2, or 1 minutes. Since the volume of the concentrator pump also limits the volume of fluid taken up, the gating component 372 is optional but can improve the precision of operation of the device.

With further reference to FIGS. 3A-3C, in an aspect of the disclosed invention, the amount of preconcentration of the sample may be controlled, e.g., to a defined amount of preconcentration. The height that the gating component 372 is mounted on the housing can be used to concentrate to the exact amount of sample that is needed for the assay. For example, imagine that the membrane area exposed is 9 cm², and the horizontal interior area of the vacuum reservoir housing 370 is also 9 cm². If the gating component 372 is placed 1 cm above the membrane, then 9 cm³ (9 mL) of sample fluid 342 will be drawn through the membrane before the gating component is dissolved and the flow ceases. If the original volume of sample fluid used in the device is 10 mL, and 9 mL is drawn through the membrane before the gating component is dissolved, then there will be a 10× preconcentration of an analyte such as cortisol, vasopressin, or a viral protein or antibody in the sample. Similarly, without the gating component, the vacuum housing 370 could just depressurize due to fluid intake, but this may take longer since as pressure difference decreases the draw rate also decreases. The device 300 may be designed to favor even faster preconcentration and faster transport to the sensor 320 (e.g., less than 5 minutes) by not relying fully on the gating component 372, but also using other ways to cease draw of fluid before sample fluid 342 is wicked onto the sensing portion of the device 300. Depending on the location of the gating component, operation time can range from <1 minute to 10's of minutes. Although a sensor 320 is shown and described, it may also be optional, and wicking material 330 may be a material to receive the sample (e.g., a receiving portion of the device) which may then be used to transport the preconcentrated sample to a separate analyze or storage container, for example.

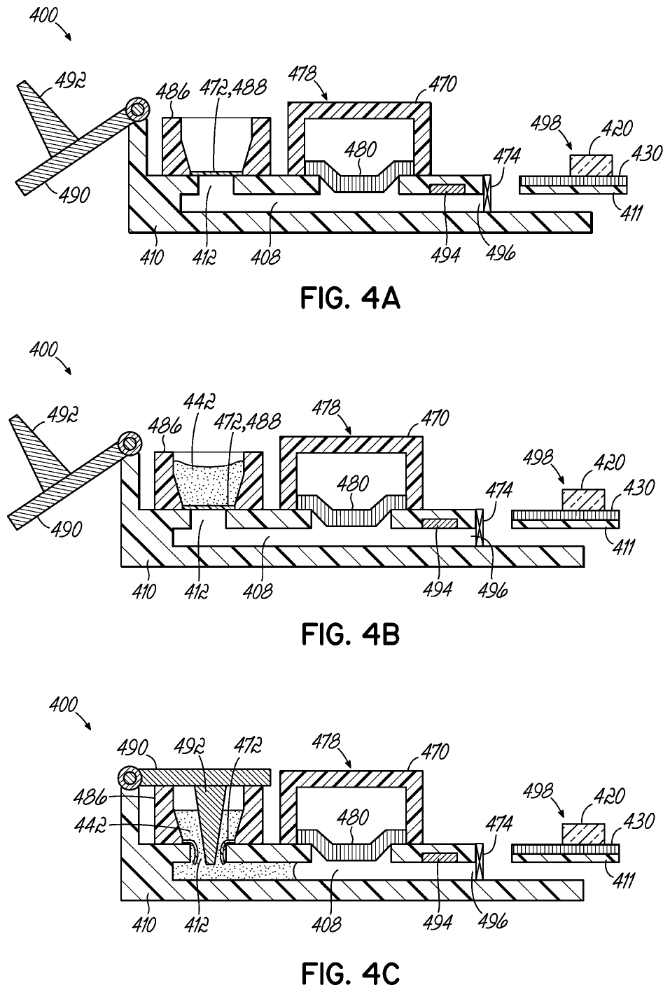

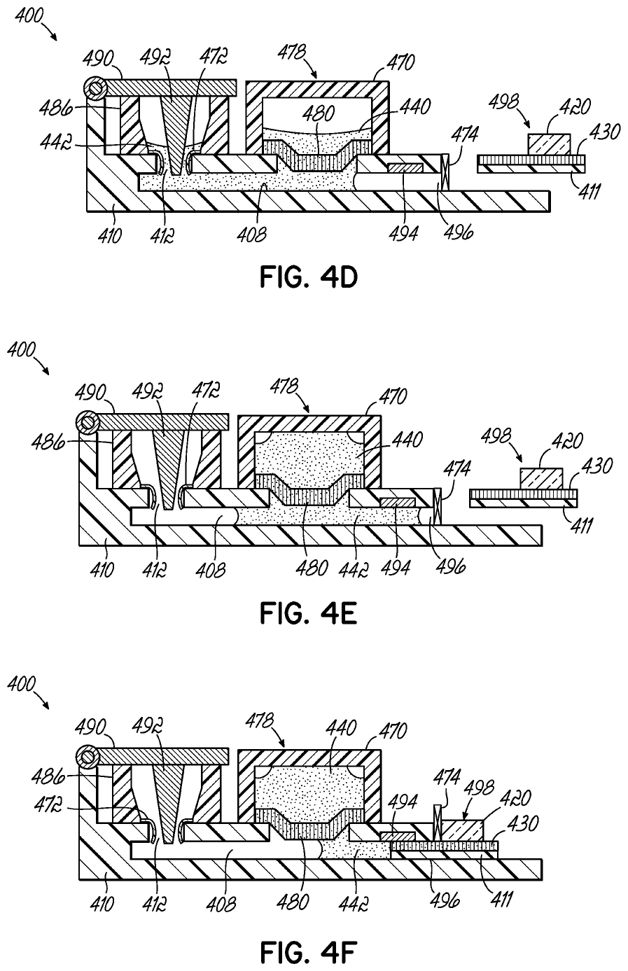

FIGS. 4A-4F illustrate another embodiment of the disclosed invention comprising a device 400 having a fluidic channel 408 with an inlet 412 and a draw reservoir 478. Like the draw reservoirs of previously described embodiments, the draw reservoir 478 includes a gas impermeable housing and a semi-permeable membrane 480 that forms a portion of a wall of the fluidic channel 408. Like the previously described reservoirs, the draw reservoir 478 of the present embodiment of the device 400 may also include a gas impermeable substance coating the semi-permeable membrane 480, as well as an optional material creating a chemical reaction to assist with maintaining fluid drawn into the reservoir 478 in a liquid state, and a gating component that releases the vacuum in the draw reservoir 478 when the fluid pulled into the draw reservoir 478 reaches a desired volume. The device 400 includes an inlet reservoir 486, an inlet cover 488, and a cap 490 having a structure 492 for allowing a sample to pass through the inlet cover 488 when the lid is moved to a closed position. In the illustrated embodiment, the inlet reservoir 486 is formed by a continuous wall that surrounds the inlet 412 to the fluid channel 408. The wall extends up from the top surface of the device 400 and providing a reservoir having a predefined volume. The wall of the inlet reservoir 486 may be made from the same material as the channel 408 of the device 400 or made from a different material.

In the illustrated embodiment, the device 400 also includes an indicator 494 that indicates when the sample has completed preconcentration. The illustrated embodiment also includes an outlet 496 at the opposite end of the fluid channel 408 from the inlet 412. A Lateral Flow Assay 498 (LFA) may be inserted into to outlet 496 to analyze the preconcentrated sample. The outlet 496 may include a rupturable foil or film or valve. In embodiments of the disclosed invention, the LFA may be incorporated into the device as illustrated with previously described devices making the indicator 494 and/or outlet 496 unnecessary. In embodiments of the disclosed invention, the LFA 498 may include a sensor for analyzing the preconcentrated fluid, a preconcentrated sample storage reservoir, a wicking material for drawing the preconcentrated material to the sensor and/or preconcentrated storage reservoir, a downstream vacuum chamber or combinations thereof.

The device 400 requires only two user actions: (1) adding a volume of sample to the inlet reservoir 486 and closing the lid 492; and (2) coupling the assay or storage component, such as LFA 498, to the outlet 496 when an indicator 494 says the sample is ready.

In FIG. 4A, the device is shown in an unused state. Like device 300, the concentrator pump in device 400 also uses a pressure gradient to exert a force to draw water across membrane 480. Since this pressure gradient is established by evacuating the space within the device, it would ideally be stored in a vacuum sealed foil enclosure. A substrate 411, wicking material 430, and sensor 420 may be used with device 400. One such example is an LFA.

In FIG. 4B, the device 400 is placed on a table or surface, and a sample fluid 442 is added to the inlet reservoir 486. The fluid 442 is unable to enter the inlet 412 of the fluid channel 408 of the device 400 because at the bottom of the inlet reservoir 486 is a gating component, such as an inlet cover 488 formed by a rupturable foil, film, or valve. The back end of the device 400 includes another gating component 474 such as a sealed outlet formed by a foil, rupturable film, or valve.

In FIG. 4C, the device 400 inlet reservoir 486 is closed with a cap 490 that also ruptures the inlet cover 488 with the structure 492. In another embodiment in which the inlet cover 488 is a valve, closing the cap 490 opens the inlet valve. In an embodiment, the cap 490 provides a ‘click’ or other indicator that it has been properly closed. Another approach for introducing a sample fluid to the device 400 is possible with a key requirement being a mechanical action introduces fluid into the inlet 412 of the channel 408. An advantage of the illustrated embodiment is that shutting in a sample fluid, such as a biofluid, prevents spillage of the sample. The cap 490 has some gas permeability when closed, which can be achieved by a semi-tight hydrophobic seal or hydrophobic vent or other suitable methods. Once the inlet cover 490 is ruptured, fluid moves into the inlet 412 of the channel 408 of the device 400 via vacuum pressure and also possible capillary action. The vacuum pressure from the draw reservoir 478 and, optionally, from a vacuum in the channel 408, should cause this to occur very quickly.

In FIG. 4D, the fluid sample 442 is preconcentrating within device 400.

In FIG. 4E image, the fluid 442 has completed being preconcentrated. Note, a gating component like previously taught could be added to enhance the speed movement of the fluid through the device 400 and avoid the slow final phases of equilibrating pressure in the draw reservoir 478 and the channel 408. After the sample fluid is preconcentrated, it is then able to move onto the visual indicator 494, which changes color or performs some other sort of indication to let the user know preconcentration is complete. In embodiments of the disclosed invention, a dye is not desired in the indicator 494, as it could interfere with visual reading of the LFA 498 unless the dye is separated from the preconcentrated sample by a semipermeable membrane that prevents contamination of the preconcentrated sample with the dye. Embodiments of the disclosed invention utilize a simple color changing film in the indicator 494 that changes when it gets wet, like those sold by Crayola, may be suitable.

In FIG. 4F, a user inserts the sensor or lateral flow assay into the device 400, rupturing the gating component 474. Alternatively, the user could peel or remove the gating component 474 to expose the concentrated fluid sample. This doses the preconcentrated fluid sample onto the wicking material 430 where it reaches sensor 420. A mechanical stopping point, visual indicator, or other approach can be provided to clearly let the user know how far the lateral flow assay needs to go into the device 400.

Some additional advantages of this approach are low fluid resistance because vacuum is used to pull fluid forward and the inlet will readily let air in so that fluid can flow onto the LFA. This requires that the gating component 472 be properly displaced or spread by the cap 490 closing in FIG. 4C.

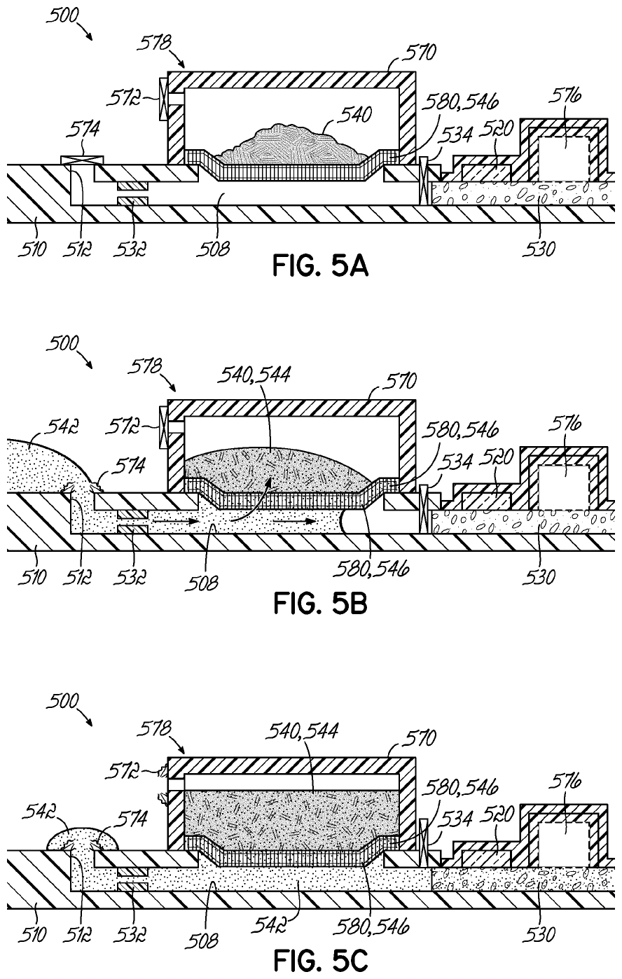

With reference to FIGS. 5A, where like numerals refer to like features already described in FIG. 3A, a device 500 is also capable of preconcentrating a sample fluid before the sample is sensed using a concentrator pump that relies on a gas-evacuated region of the device. The device 500 includes a fluidic channel, which is held under vacuum, between substrates 510 that may contain wicking material 530. The wicking material 530 may be made of, for example, cellulose, or a material with low non-specific binding of analyte, including open microfluidic materials or a matrix of packed hydrophilic glass beads where fluid wicks between the beads. If the device 500 does not contain the wicking material 530, then it could have another vacuum chamber 576 to further pull the liquid through the channel after it preconcentrates. A flow restrictor 532 may be present near the inlet of the fluidic channel or at other locations if necessary. A dissolvable or gas impermeable film 574 is covering the inlet of the fluidic channel, maintaining the depressurized state of the channel. For example, film 574 could be gelatin or sucrose or polyvinylachohol film, or a membrane ore material that operates similar to membrane 180 as taught for FIG. 3. A membrane 580 is provided along a portion of the fluid channel, and separates the fluid channel from a reservoir, which is held under vacuum, as with the previous device 300. The membrane 580 may be, for example, a dialysis membrane or track-etch membrane that preconcentrates larger analytes (e.g., molecules, large molecules, proteins, etc.) but which allows small solutes (e.g., those that affect pH and salinity) to pass through membrane 580. A small fluid blocking film or tab 534, sitting in front of the wick material 530, is blocking the latter portion of the fluidic channel, and can help direct the sample fluid through the membrane 580 into the vacuum reservoir to so that it will concentrate before proceeding onward through the device 500.

With reference to FIG. 5B, the fluid sample 542 is introduced and covers the film 574. The film 574 is rapidly dissolved, and the sample fluid 542 is drawn into the fluidic channel, which is being held under vacuum. Even though the film 574 coving the inlet has been dissolved, vacuum is maintained due to the remaining sample fluid 542 coving the inlet of the channel The sample 542 ceases to flow at the tab 534, is drawn through the membrane 580 into the vacuum reservoir, and begins to concentrate. The sample fluid 542 then mixes with the substance 540 to form substance 544, as in device 300, and catalyzes an immediate endothermic reaction to keep the reservoir cold and the sample fluid in its liquid state in order to reduce water vapor pressure that would deplete vacuum and slow or impede operation of the device 500. If membrane 580 has a molecular weight cut-off larger or equal to 2000 Da, it transports both water and small solutes from the sample into the vacuum reservoir above the membrane 580, thereby preventing a large change in pH or salinity for the sample 542 being preconcentrated beneath the membrane 580.

With reference to FIG. 5C, the volume of sample fluid 542 that has been drawn into the vacuum reservoir reaches the auto-stop gel 572 and repressurizes the device 500 as seen with previously explained device 300. The user of device 500 then can pull the tab 534 out of the device 500, and the fluid sample 542 is able to proceed onto the sensing portion 520, which may include an analyte-specific sensor. Element 534 could also be a dissolvable material and no user action needed. In device 500, wicking material 530 is optional (e.g., the sensor may be in a microfluidic channel extending from the membrane 580 past the sensing portion 520), but wicking material 530 might be preferred as it can speed transport of preconcentrated sample to the sensing portion 520 by virtue of a strong wicking force. If the wicking material 530 is not present, a second vacuum chamber 576 pulls the concentrated fluid sample through the remaining portion of the channel The amount of preconcentration, as with device 300, is predetermined by the volume of sample fluid 542 that can fill the vacuum reservoir before the auto-stop 572 is dissolved. If 99 μL of sample 542 are drawn into the reservoir before the auto-stop is dissolved, and there is one μL of sample remaining under the membrane, the effective concentration of the sample being sent to the sensor is 100×.

In some instances, the solvent used in the sample will have a high vapor pressure (such as alcohols or even water) can have a vapor pressure that causes significant vacuum loss in devices that require long/slow preconcentration times, or long/slow pumping times. A device 600 incorporates a two chamber approach. A first chamber or channel 690 will at some point contain and pull in the solvent or water. A second chamber or channel 691 is connected to the first chamber 690 by a sieve 693. The sieve 693 is any component that preferably passes dry gases (O2, N2, CO2, etc.) instead of solvent vapor.

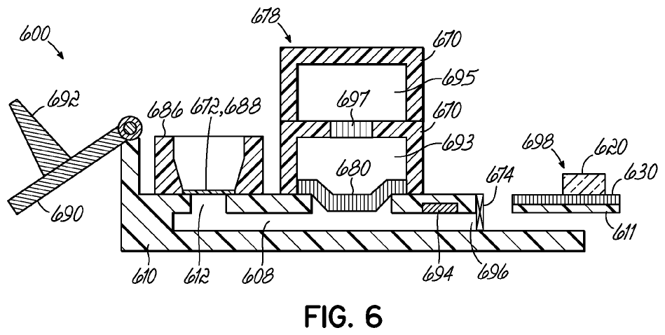

With further reference to FIG. 6, for example, the sieve 693 could be a powder held between layers of paper, such as molecular sieve powder made by Delta Absorbents or organophilic molecular sieves distributed by Sigma Aldrich. Generally, good sieve materials are good desiccant materials for water or other solvents. As a result, solvent vapor is impeded or captured as it attempts to pass through the sieve 693, and therefore the second chamber 691 vacuum pressure is less degraded by water vapor pressure than the first chamber 690 vacuum pressure. The sieve does not need to completely occlude solvent and/or solvent vapor. Materials such as PDMS could be used as a sieve material since they provide a gas porous filter while slowing the flow of solvent and/or solvent vapor.

With further reference to FIG. 6, the sieve 693 shown in device 600 can also benefit from including a hydrophobic and/or oleophobic membrane such as a track-etch membrane to prevent fluid from wetting the sieve. For example, the sieve could include hydrophobic and/or oleophobic membranes such as polyethersulfone membranes, polytetrafluoroethylene venting membranes, and fluoropolymer membranes.

With further reference to FIG. 6, this same element or membrane 693 if adequately hydrophobic or water impermeable can be used to create a gating component for vacuum preconcentration or vacuum pumping in a microfluidic device, with or without the sieve. For example, the first chamber would fill nearly entirely with fluid while the second chamber would not. This would allow at most half the vacuum pressure to be maintained during all of preconcentration if the both of the first and second chambers were of equal volume. This creates an abrupt and more precise endpoint for preconcentration (e.g. more precise amount of preconcentration) and allows a faster time to completion of preconcentration because the final vacuum pressure at final preconcentration is stronger than it would be with a single chamber. Therefore, the present invention may include at least two vacuum reservoirs separated by at least one membrane that impermeable to fluid transport.

While the depicted embodiments have shown specific numbers of sensors, it should be understood that the number of sensors may vary depending on the application. Although not described in detail herein, other steps which are readily interpreted from or incorporated along with the disclosed embodiments shall be included as part of the invention. The embodiments that have been described herein provide specific examples to portray inventive elements, but will not necessarily cover all possible embodiments commonly known to those skilled in the art.

1. A sensing device configured to receive a fluid sample, the sensing device comprising:
one or more sensors for measuring a characteristic of an analyte in the fluid sample;
a fluid channel that transports the fluid sample;
a semi-permeable membrane in contact with the fluid sample;
a concentrator pump that exerts a force to draw water and/or solutes through the semi-permeable membrane; and
at least one gating component that prevents the fluid sample from advancing past said component for a defined period of time and/or until a user's action.

2. The sensing device of claim 1, wherein at least one gating component is mechanical.

3. The sensing device of claim 2, wherein at least one gating component is removeable by the user or is caused to be removed by a user's action.

4. The sensing device of claim 2, wherein at least one gating component is puncturable by the user or is caused to be punctured by a user's action.

5. The sensing device of claim 1, wherein at least one gating component is a barrier that is removed in the presence of the fluid sample.

6. The sensing device of claim 1, wherein at least one gating component is before the semi-permeable membrane.

7. The sensing device of claim 1, wherein at least one gating component is after the semi-permeable membrane.

8. The sensing device of claim 1, further comprising at least one visual indicator to prompt said user's action.

9. The sensing device of claim 6, wherein at least one visual indicator is a dye or film.

10. A sensing device configured to receive a fluid sample, the sensing device comprising:
one or more sensors for measuring a characteristic of an analyte in the fluid sample;
a fluid channel that transports the fluid sample;
a semi-permeable membrane in contact with the fluid sample; and
a concentrator pump that exerts a force to draw water and/or solutes through the semi-permeable membrane;
wherein the device is configured to prevent the fluid sample from reaching the one or more sensors until a defined amount of fluid is removed from the fluid sample or until a defined volume is reached.

12. The sensing device of claim 10, wherein the concentrator pump removes water faster than the fluid sample advances within the fluid channel.

13. The sensing device of claim 10, wherein the capacity of said concentrator pump is configured to remove a defined volume from the fluid sample.

14. The sensing device of claim 12, wherein the concentrator pump includes a water-soluble vent that reduces the apparent capacity of the concentrator pump.

15. The device of claim 10, wherein the concentration of said analyte is increased by a factor of at least one of 2, 5, 10, 50, or 100.

16. The device of claim 10, wherein salt concentration in the fluid sample changes by less than at least one of 10×, 5×, 2×, 0.5×, 0.25×, 0.1×, or 0.05×.

17. The device of claim 10, wherein pH in the fluid sample changes by less than at least one of 1000×, 100×, 10×, 2×, or 0.5×

18. The device of claim 10, wherein an assay is placed after the water-permeable membrane.

19. The device of claim 10, wherein said at least one sensor, assay, or sample reservoir is to be utilized one and only one time.

20. The device of claim 10, wherein said assay receives fluid with a flow rate that is compared to a device with the same assay and having no preconcentration that is less than at least one of 10×, 5×, 2×, 0.5×, 0.25×, or 0.1×, different than flow rate would be for said device without preconcentration.

21. The device of claim 10, further comprising at least one vent that reduces fluid flow resistance through said device.

22. A method of concentrating an analyte in a sample comprising:
introducing a fluid to an inlet of a channel in a device;
passing the sample over a semipermeable membrane that is impermeable to the analyte but permeable to other components of the fluid;
applying a force to the sample sufficient to result in at least a portion of the permeable components of the fluid to pass through the semipermeable membrane into a concentrator pump until the analyte is preconcentrated to a defined level; and
releasing the preconcentrated analyte containing fluid onto at least one of an assay, sensor, or sample collector.

23. The method of claim 22, wherein the introducing a fluid to the inlet comprises: introducing the sample to an inlet reservoir having a gating component, mechanically causing the sample to pass through the gating component to the inlet of the microchannel device.

24. The method of claim 23, wherein the step of mechanically causing the sample to pass through the gating component comprises closing a cap on the device that ruptures the gating component.

25. The method of claim 22, wherein the step of releasing the preconcentrated analyte containing fluid comprises introducing the at least one of an assay, sensor, or sample collector through a second gating component at the end of the device after the sample has completed preconcentrating the analyte.

26. The method of claim 22, wherein the step of applying a force comprises applying an osmotic force, a wicking force, a negative pressure force, a positive pressure force, or combinations thereof to the sample.

27. A preconcentration device configured to receive a fluid sample, the device comprising:
a permeable membrane; and
a draw reservoir in contact with the membrane;
wherein the draw reservoir is configured to be at a lower gaseous pressure than the surrounding environment to draw fluid solvent and/or solutes through the membrane and therefore preconcentrate at least one analyte in the fluid.

28. The device of claim 27, wherein the semi-permeable membrane is gas impermeable.

29. The device of claim 28, wherein the semi-permeable membrane includes at least one gas impermeable material.

30. The device of claim 27, further comprising at least one sealing component that is gas impermeable.

31. The device of claim 30, wherein the at least one sealing component is permeable to the fluid sample.

32. The device of claim 30, wherein the sealing component is mechanically puncturable or removeable by a user.

33. The device of claim 27, further comprising a flow restrictor that reduces the flow rate of the fluid sample.

34. The device of claim 27, further comprising a component configured to draw the fluid into the device.

35. The device of claim 34, wherein the component configured to draw the fluid into the device is a wicking channel or material.

36. The device of claim 34, wherein the component configured to draw the fluid into the device is a second draw reservoir.

37. The device of claim 27, further comprising at least one sensor capable of measuring a characteristic of an analyte in the fluid sample.

38. The device of claim 27, wherein the device further comprises a fluid and/or gas impermeable pouch that encases said device.

39. The device of claim 32, wherein the device further comprises a component configured to puncture or at least partially remove the sealing component.

40. The device of claim 39, wherein the component configured to pierce the sealing component provides auditory feedback to the user.

41. The device of claim 37, wherein at least one sensor, initially physically isolated from the device, is configured to be inserted into the device by the user.

42. The device of claim 41 wherein the device further comprises a visual indicator that indicates when a user should insert said at least one sensor into the device.

43. The device of claim 42, wherein the visual indicator is a dye or film.

44. The device of claim 27 wherein the device further comprises:
at least a second draw reservoir coupled to the draw reservoir by a coupling membrane.

45. The device of claim 44, wherein the coupling membrane is at least partially comprised of a material that selectively passes dry gases at a greater rate than solvent vapor.

46. The device of claim 44, the coupling membrane is impermeable to the solvent of the fluid sample.

47. The device of claim 27 including at least one gating component.

48. The device of claim 47 wherein the gating component is attached to the draw reservoir.

49. The device of claim 47 further comprising at least one sensor, wherein the gating component after the membrane but before at least one sensor.

50. The device of claim 27, further comprising a desiccant.

51. The device of claim 27, further comprising check valve.

52. The device of claim 1, wherein the concentration of said analyte is increased by a factor of at least one of 2, 5, 10, 50, or 100.

53. The device of claim 1, wherein salt concentration in the fluid sample changes by less than at least one of 10×, 5×, 2×, 0.5×, 0.25×, 0.1×, or 0.05×.

54. The device of claim 1, wherein pH in the fluid sample changes by less than at least one of 1000×, 100×, 10×, 2×, or 0.5×

55. The device of claim 1, wherein an assay is placed after the water-permeable membrane.

56. The device of claim 1, wherein said at least one sensor, assay, or sample reservoir is to be utilized one and only one time.

57. The device of claim 1, wherein said assay receives fluid with a flow rate that is compared to a device with the same assay and having no preconcentration that is less than at least one of 10×, 5×, 2×, 0.5×, 0.25×, or 0.1×, different than flow rate would be for said device without preconcentration.

58. The device of claim 1, further comprising at least one vent that reduces fluid flow resistance through said device.
